(19) United States
(12) Patent Application Publication
(10) Pub. No.: US 2008/0040766 A1
(43) Pub. Date: Feb. 14, 2008

(54) Video display device and method for limited employment to subscribers proximate only to authorized venues

(76) Inventors: Atul Mansukhlal Anandpura, San Diego, CA (US); Sunil Hitendrasinh Solanki, San Diego, CA (US); Nagvendra Singh, San Diego, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/891,196

(22) Filed: Aug. 8, 2007

Related U.S. Application Data
(60) Provisional application No. 60/837,271, filed on Aug. 10, 2006.

(51) Int. Cl. H04N 7/173

(52) U.S. Cl. 725/131; 725/104

(57) ABSTRACT

A method of providing video portable video display device having a video screen for viewing of video streams broadcast at various venues such as sports events. Users are informed of upcoming events and venues and may buy a subscription to operate the video display at each event. For each event the user is given an authorization code which is stored in the device. Upon arrival of a user at the venue, the authorization code is transmitted and if determined valid, an activation signal is broadcast to activate the device to receive wireless video transmissions. Removal of the device from the venue or ending of the event will deactivate the device.

### FIELD OF INVENTION

This application claims the benefit of U.S. Provisional Patent Application No. 60/837,271, filed Aug. 10, 2006. This invention relates generally to portable video displays. More particularly it relates to a video display device providing a user with an alternate video display of an event at a venue and a method of limiting employment thereof to authorized dates and for time durations only when the device is sufficiently proximate to designated appropriate venues on an authorized date, thereby limiting use of the device on unauthorized dates or outside a designated proximity to the authorized venue.

### BACKGROUND

Sporting events such as professional boxing, soccer or football are attended by thousands of fans for each game. Additionally, some events are broadcast to smaller venues across the country such as bars and restaurants where patrons can view the event while enjoying the company of friends and the music, food and drink of the bar or restaurant. This is especially true in the case of “pay per view” type events such as championship boxing. Other events such as plays, opera, dance performances, concerts and the like also are attended by audiences who view the live event from a seat in the theater or outdoor stadium. For all such events, many patrons and fans yearn for a “better seat” or with a better view of the event, or of instant-replays of occurrences in the event. In other cases, such as at gambling or bingo games, or in a bar or nightclub offering group playing of an electronic game, there may be a group of players attending who must be inside the venue on an authorized night to legally participate. However, the bingo hall or bar offering a group competition game or similar group venue can become overcrowded, thereby rendering the action on stage or in the arena hard to hear and see. Horse races too are attended by thousands of betting fans many of whom cannot see the finish line, the current odds, or the horse on which their bets depend.

In the case of sporting events such as football and soccer, whether viewed in the stadium or at a sports bar, there exists an insatiable need for more and better viewing of the event, as well as a desire of fans to be able to re-play events during the game. When viewed in a sports bar or gambling casino, there also exists the need to see the event unfold from seating that might not be close to a group-viewed screen for a clear or unobstructed viewing.

Further, at many venues such as race tracks or motocross tracks covering many acres of a serpentine track, there may be many positions about the track where a plurality of different participants in the event are concurrently performing their sporting or athletic feats. Because, fans and attendees are also situated at a plurality of positions at the venue, they often miss viewing many such occurrences at the event because they cannot see from their assigned or current seats.

Accordingly, there is an unmet need for a device to provide a personalized video display to users at individual venues for any type of contest or sporting event or other event attended by fans and patrons. Such a device should be easily adaptable to the event intended whether it be a football game, a horse race, a bingo parlor having gambling, a sports bar offering patrons group viewing of a sporting or other event, or anywhere fans and patrons desire individualized viewing of the event.

In order not to detract from attendance at the event, or authorized remote viewing venues for the event, such a device should be operable only when the user and device are sufficiently proximate to an authorized viewing venue for the device rendering video of the designated event. Further, such a device should also be operable only on authorized dates, at authorized times of use when in the required sufficient proximity to an authorized viewing venue.

In cases of parimutuel betting or gambling venues, such-a device would additionally be especially useful if it not only displayed the event itself and/or replays of the event, but also allowed users to place their bets from positions remote to the betting window at the venue. For instance, at a Las Vegas Casino such a device would allow bettors on sports events, horse races or Keno to wander the casino, watch the results on the video display, and place new bets while being remote to the actual betting window. However, since the device would only work when at a certain proximity to the betting window or authorized casino, unauthorized betting outside a distance proximate to the betting window or the casino would be prevented.

Further, such a device should provide for easy intuitive user-input of the type of video they wish to view of the event, and if available, allow user chosen multiple viewing angles of the event. In cases of use in sports stadiums with playing fields surrounded by spectator seating, the viewing angles on each device of the playing field would be displayed relevant to the user's position in the stadium through an interface allowing user choice of viewing angle.

Still further, in cases where the device is distributed remote to the event and paid for by the user, such a device should only be operational when the user is sufficiently proximate to the venue, on the correct date and time, and enters an authorization code communicated to the viewer prior to the event. This would allow the device to be sold or distributed to users prior to one or more events and thereafter used only when sufficiently proximate to the authorized venue, on the proper date, and only by the authorized user attending who has the correct code, thereby dissuading theft of the devices since they would be rendered inoperable without the proper code for the date and venue where they are to be used.

### SUMMARY OF THE INVENTION

There is disclosed and described herein a portable video display device and method of sale and use of such a device, which employs an onboard video display screen such as an LCD, viewable by the user. Also provided is a keypad interface having intuitive keys positioned to initiate video at viewing angles relative to the user position around the playing field that allow the user to input any of a plurality of desired viewing angles if multiple angles are offered at the event being attended.

As shown in the drawings the display is provided by an LCD onboard the device which is powered by a battery. Onboard memory would provide data to a data processor and optionally an interface in the form of a card slot could be provided to allow memory and/or card-oriented data to be communicated to the device, or an authorization card inserted, without which the device would be inoperable. Sound would be provided by onboard speakers or headphones which can be engaged in a headphone jack. Connectors for USB or Cat 5 or other means for wired or wireless engagement could also be provided so the device could be programmed via a computer or on a network remotely. When at the authorized venue, wireless communication would employ an antenna and onboard receiver or an infrared transceiver to communicate video and/or data to the device and from the device to receivers at the venue. Software onboard adapted for the noted functions would run on an onboard computing device or microprocessor adapted to the task.

In a method of use, the devices would be available for use by subscription over the internet or at the venue where it is to be employed or at authorized pick-up venues. The device would be placed in the possession of a user and an encrypted code generated which must be input or received by the device prior to use at each event to be attended by a user. The code would be transmitted to the device using wireless or wired communication and held in memory. A matching code would also be generated.

The user, once sufficiently proximate to the authorized event on the authorized day, would be in possession of the display device. Onboard wireless communications on the device once sufficiently proximate to an authorized venue would either seek communications with a communications node at the venue, or the device would be taken to a designated point at the venue where a communications node is located. The device would then communicate with the node its stored authorization code and if that code is authenticated as genuine by the receiving computer, the device would be activated by a signal from the node.

The communication node for the devices coming into the venue might be at an entrance gate or might be capable of stadium or venue-wide communication. Proximity to the venue would be required and could be determined by either the strength of wireless signals being such that communication would not work if the device is not sufficiently proximate to the venue, or the device could be enabled with GPS or radio triangulation to determine its exact geographic location and communicate that location to the node with the authentication code.

Authentication would only be allowed if the location communicated is within or sufficiently proximate to the venue. Authentication would be provided by communications at the authorized venue over a local or wide area network communicating with an authenticating computer, or by storing data at the venue as to authorized codes already issued to users, for the date and time of the event, and matching the data with user devices communicating their stored authorization codes when seeking authentication to operate.

As such, users could obtain the display devices in advance and then buy a subscription for use of the device at any of thousands of venues for the specific time and date for an event. The devices would store in onboard memory, one or a plurality of event authorization codes and seek authentication to operate by wireless or other communication when transported sufficiently proximate to the authorized venue at the authorized time and date of the event.

For example, users might buy a subscription to use the device at a football game, a bar showing a prize fight, or at a car race and receive authorization codes for each event which are stored in memory of the display device. Once the user arrives at the venue for each event at the proper time and date, the device will seek authorization by transmitting the authorization code for the event to the node at the venue. The device would then be turned on by communication from the node at the venue subsequent to a match being ascertained of the authorization code with a stored list of authorization codes for the venue for the duration of the event. Subsequent events subscribed to would be handled in the same fashion.

In cases of casino or horse racing, the devices could either be distributed to users in advance as above or given to users for a single event subscription right at the venue. If two-way communication is available, the devices would be able to communicate bets on events while in the designated proximity to the venue during the authorized time of use. As a failsafe, transmitters at exits to the venue would transmit a signal to disable the devices as they left the venue.

In cases where the display devices are employed in a large stadium or large venue, means for determining the location of the device relative to the playing field or track at the venue can be provided. This would be by GPS or radio triangulation or other means of determining geographic position. Upon the device ascertaining the user's position relevant to the playing field surrounded by viewing seats at the venue, a keypad offering a plurality of viewing angles relevant to their location can be provided for user input to provide video such as instant replay to be displayed on the device at angles relevant to their position from multiple video streams from cameras capturing the playing field or track at different angles at the venue.

In this respect, before explaining at least one embodiment of the device herein in detail, it is to be understood that the invention and method is not limited in its application to the details of construction and to the arrangement of the components or method steps set forth in the following description or illustrated in the drawings. The invention is thus capable of other embodiments and of being practiced and carried out in various ways and in different order of execution. Also, it is to be understood that the phraseology and terminology employed herein are for the purpose of description and should not be regarded as limiting.

As such, those skilled in the art will appreciate that the conception upon which the system and method is based may readily be utilized as a basis for designing of other methods and software driven systems for carrying out the several purposes of the present invention. It is important, therefore, that the claims be regarded as including such equivalent construction insofar as they do not depart from the spirit and scope of the present invention.

It is an object of this invention to provide a video display device and subscription service thereto providing individualized video display to subscribing users.

It is a further object of this invention to provide such a device, wherein the purchased subscription employs operative software to allow operation of the device only proximate to specific venues and on dates and times authorized by a prepaid subscription.

An additional object of this invention is to provide such a service with a device that optionally allows for easy orientation of the device to its position at an authorized venue using electronic means or manual input by a user.

A still further object of this invention is the provision of such a subscription service which will allow for video display devices to be programmed over the world wide web with authorization codes enabling them only to operate when proximate to an authorized venue at an authorized time and date.

These together with other objects and advantages which will become subsequently apparent reside in the details of the construction and method as more fully hereinafter described and claimed, reference being had to the accompanying drawings forming a part thereof, wherein like numerals refer to like parts throughout.

### BRIEF DESCRIPTION OF DRAWING

FIG. 1 depicts an exemplar flow chart of a method of providing display devices to authorized users for authorized venues.

FIG. 2 depicts a portable display device typical of those employed with the method herein providing keys for user input of multiple viewing angles relevant to the user's position if such are available.

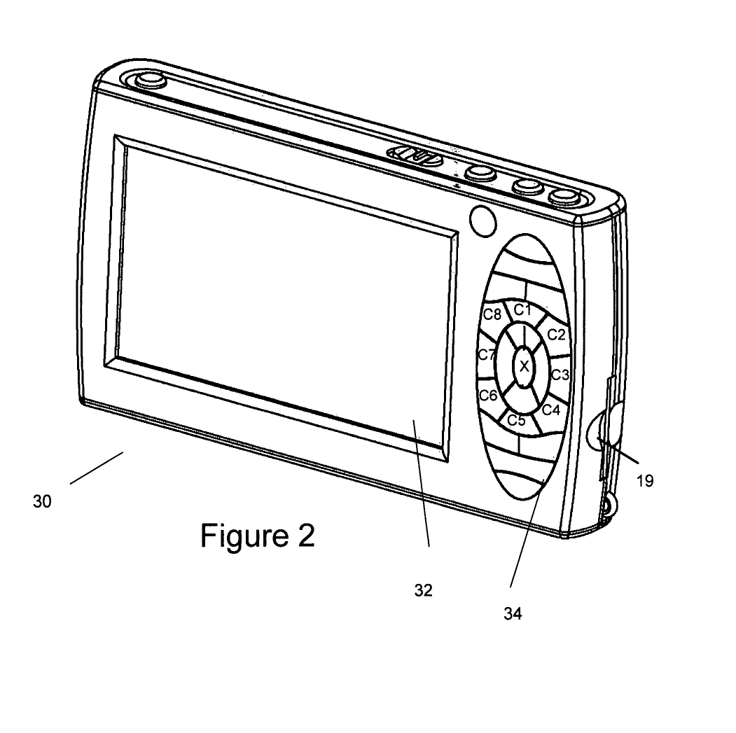

### DETAILED DESCRIPTION OF PREFERRED EMBODIMENTS

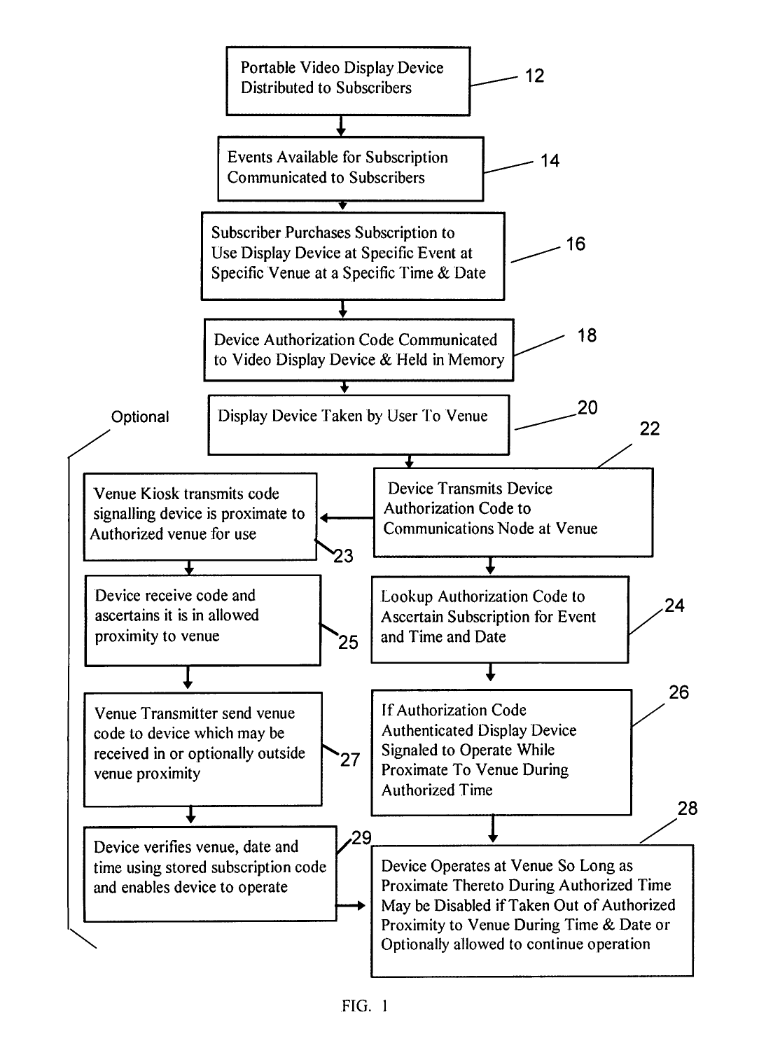

As noted, FIG. 1 the method 10 would follow the general steps of providing a portable video display to subscribers 12 or potential subscribers. Also communicated over the internet or other means of communication would be a listing of events available for a subscription to subscribers 12 where the video device 30 will operate in the future. From the listing, subscribers would then be able to purchase a subscription for an event at a specific venue, time and date 16. Subsequent to the purchase over the internet or at an authorized physical location, an authorization code 18 is communicated to be stored in the video display device 30 and held in memory 16. One or a plurality of such authorization codes 18 may be so communicated and stored. Alternatively a card slot 19 can be provided to allow memory and/or card-oriented data and authorization codes to be communicated to the device. This would allow the sale of authorization codes on cards that can be inserted or venue data to be inserted on a memory card.

The user would then travel to the event at the appropriate venue making sure to arrive during authorized times on the correct date 20. The device may be authorized to operate longer than the event itself to allow for early arrivals and late departures or games. Once at the event, at the correct venue and at the right time and date 20, the video device 30 would be turned on and a communication would be initiated by the device of the stored authorization code to a communications node located at the venue 22. Initiation of the authorization code broadcast may be automatic when turning the video device on, or by pressing a button once turned on.

A server or computer in communication with the node at the venue, receives the authorization code communicated from the video device 30 and performs a lookup to ascertain if the authorization code communicated authorizes use at the venue, during the time and on the date received 24.

If the code is correct and authentication occurs, a signal 26 is sent to the video device 30 activating it to operate, but only while in a proximity to the venue and on the date and at the time paid for in the subscription. The device operates as long as it continues at the correct location for the duration of the event. However, if the device moves out of the allowed proximity, operation will terminate 28. This can be done by sending the signal 26 to operate every few minutes and having the device monitor for the signal 26 and shut off if not received. Or GPS or other means can be used to determine if the device is in the proper proximity to the authorized venue for use.

Alternatively, device 30 would receive a code from a server or computer indicating that the device is within the allowed proximity of the venue 23. Once, this code is received, device 30 will begin to look for other signals being transmitted by the venue communications node. The venue communications node would then transmit venue code 27. If the venue code matches with the venue authorization code stored on the device (after ascertaining that the device is in the allowed proximity), the onboard computer will enable the device to operate 29 and the device will be enabled to receive and display video signals communicated from venue cameras.

The typical video device 30 will provide an LCD video screen 32 and user operable keypad 34 which as shown features a plurality of input buttons C1-C8 positioned around a center point x, on the keypad indicating possible video available from cameras at the venue. The device having determined its relevant position at the venue will employ software onboard to adjust the input buttons C1-C8 such that the video displayed on the device 30 from the different camera angles being broadcast at the venue will always be relevant to the user's position in the venue. For example, pressing the input button in the 6 o'clock position or C5 closest to the user, will always cause the camera feed immediately behind the user to be displayed. Pressing the input button C1, in the 12 o'clock position relative to the user will always cause the camera feed from the opposite side of the playing field from the user to be displayed. The device will automatically determine its relevant position to the playing field and make the camera feed adjustments to mate with the appropriate input button C1-C8.

The subscription method of providing portable video displays and the device shown in the drawings and described in detail herein features arrangements of elements of particular construction and configurations for preferred embodiments of the present invention. It is to be understood, however, that elements of different construction and configuration and other arrangements thereof, other than those illustrated and described, may be employed for providing a device within the spirit of this invention.

As such, while the present system and method of the invention has been described herein with reference to particular embodiments thereof, a latitude of modifications, various changes and substitutions are intended in the foregoing disclosure, and it will be appreciated that in some instance some features of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. A method of providing video portable video display device and video for display on a video screen on said display device comprising the steps of:
providing a portable video display having a video screen for displaying videos to users;
communicating to said users a listing of future events at venues where said video display will operate;
allowing said users to purchase subscriptions for use of said video display at any of said future events;
for said purchased subscriptions communicating an authorization code to said video display for storage in electronic memory;
upon arrival of a user at a said venue for a said event, providing for a transmission of said authorization code by said video display;
in response to said transmission of said authorization code from said video display, ascertaining if said authorization code is valid to authorize use of said video display at said venue;
if said authorization code is determined valid, transmitting an activation signal to said video display causing activation of said display to receive wireless transmissions broadcasted at said venue;
employing means to continuously determine the location of said video display proximate to said venue, and to deactivate said video display should it move out of proximity of said venue;
for the duration of said event at said venue, wirelessly transmitting one or a plurality of different video streams for display on said video screen of said video display; and
deactivating said video display should it move outside proximity to said venue or at an end of said event.

2. The method of providing video portable video display of claim 1 additionally comprising:
providing onboard means to determine a geographic position of said portable video display relative to a field of view for spectators at said venue;
transmitting a plurality of different video streams providing different angles of said field of view for display on said video screen of said video display;
providing a user activated keyboard having a plurality of user activated angle designation keys placed at positions around a central point representing said field of view, with each said angle designation keys representing a different viewing angle toward said field of view;
allowing said user to choose a desired said viewing angle for display on said video screen; and
correlating said geographic location of said video display relative to said field of view, with the correct one of said individual video streams to produce said desired viewing angle on said video screen.

3. The method of providing video portable video display of claim 1 additionally comprising:
providing said display for use at gambling venue having gambling and which is remote from said field of view; and
providing input means for said user to place bets using said video display.

4. The method of providing video portable video display of claim 1 additionally comprising:
broadcasting a transmission which deactivates said portable video display if it leaves a designated confine at said venue.

5. The method of providing video portable video display of claim 2 additionally comprising:
broadcasting a transmission which deactivates said portable video display if it leaves a designated confine at said venue.

6. The method of providing video portable video display of claim 3 additionally comprising:
broadcasting a transmission which deactivates said portable video display if it leaves a designated confine at said venue.

7. The method of providing video portable video display of claim 2 additionally comprising:
providing said display for use at a gambling venue having gambling and remote to said venue having said field of view; and
providing input means for said user to place bets.

8. The method of providing video portable video display of claim 5 additionally comprising:
broadcasting a transmission which deactivates said portable video display if it leaves a designated confine at said venue.
